(19) United States
(12) Patent Application Publication
(10) Pub. No.: US 2008/0159673 A1
(43) Pub. Date: Jul. 3, 2008

(54) Vehicle Wheel Bearing Apparatus

(75) Inventors: Masahiro Muranaka, Shizuoka-ken (JP); Detlef Sokolowsky, Ostfildern (DE); Daniel Nullmeier, West Bloomfield, MI (US)

Correspondence Address: HARNESS, DICKEY & PIERCE, P.L.C., P.O. BOX 828, BLOOMFIELD HILLS, MI, 48303, US

(73) Assignee: NTN Corporation, Osaka (JP)

(21) Appl. No.: 11/795,987

(22) PCT Filed: Jan. 27, 2005
(86) PCT No.: PCT/JP2005/001570

§ 371 Date: Oct. 31, 2007

(51) Int. Cl. F16C 32/00

(52) U.S. Cl. 384/448

(57) ABSTRACT

A vehicle wheel bearing apparatus that protects the encoder, improves the sensing ability of the detecting sensor, prevents penetration of rain water or dust, and prevents leakage of differential gear oil has an inboard side seal (13) with an annular supporting plate (17a) fit onto the outer circumferential surface of one of the inner rings (10). A purser ring (17), having an encoder (17b), is bonded on the outer circumferential surface of the supporting plate (17a). A sealing plate (16), including an annular core member (18 and 22), is fit onto one end of the outer member (4) and covers the cylindrical portion of the encoder (17b). A lip (19a) is bonded on the core member (18 and 22) and is in sliding contact with the inner ring (10). A detecting sensor (20) is suspended from an axle housing “H” and opposes the encoder (17b) via a predetermined radial gap. Sealing lips (18b and 19c) on the sealing plate 16 are arranged between the core member (18 and 22) and the axle housing “H” to seal the detecting sensor (20).

### BACKGROUND OF THE INVENTION

1. Field of the Invention

The present invention relates to a bearing apparatus for a wheel of vehicle for rotatably supporting the wheel relative to a suspension apparatus of vehicle, and more particularly to a bearing apparatus for a wheel of vehicle a driving wheel is supported by a double row rolling bearing.

2. Description of Background Art

In a vehicle such as a truck having a body of frame structure, an axle structure of driving wheel of full-floating type has been adopted. Recently, an axle structure in which a double row rolling bearing is united has been adopted in many cases in order to improve the readiness of assembly and to reduce the weight and size thereof. In such a bearing apparatus, it has been known a rolling bearing for a wheel of vehicle having a sealing device integrated with a encoder for detecting the rotation speed of wheel.

For example as shown in FIG. 5, such a bearing apparatus for a wheel of vehicle has first and second annular sealing plates 62 and 63 fitted respectively on an inner ring 60 and an outer ring 61. Each of these sealing plates 62 and 63 has a substantially “L”-shaped cross-section formed respectively by a cylindrical portion 62a and 63a and a radially extending portion 62b and 63b and the sealing plates 62 and 63 are arranged oppositely to each other. The radially extending portion 62b of the first sealing plate 62 has an encoder 64 for detecting the rotation speed of wheel which is bonded to the portion 62b via vulcanization at the outboard side of the bearing. The encoder 64 is made of rubber magnet in which magnetic substance powder is mingled and N and S poles are alternately magnetized along the circumferential direction of the encoder.

The second sealing plate 63 has a sealing member 65 which is bonded thereto via vulcanization and has an integrally formed side lip 65a slidably contacting with the radially extending portion 62b of the first sealing plate 62 and other integrally formed radial lips 65b and 65c slidably contacting with the cylindrical portion 62a. A tip of the radially extending portion 62b of the first sealing plate 62 is opposed to the cylindrical portion 63a of the second sealing plate 63 with keeping a slight radial gap therebetween forming a labyrinth seal 66.

In such a bearing apparatus for a wheel of vehicle, dusts or sands would sometimes enter into a gap formed between the surfaces of the encoder 64 and a detecting sensor 67 arranged oppositely to the encoder 64 and thus abrade or damage the surface of the encoder 64. This is because that the encoder 64 is mounted on the inboard side of the first sealing plate 62 forming a slinger and exposed to the ambient circumstances. For overcoming this problem, it has been proposed a rolling bearing for a wheel of vehicle as shown in FIG. 6.

In this bearing apparatus, a pulse generating ring 71 comprising a holding plate 71a and an encoder 71b magnetized in multipoles is fitted on a rotating inner ring 70. The encoder 71b is made for example of elastomer filled with magnetic pieces and bonded to the holding plate 71a via vulcanization. A cover member 72 made of non-magnetic material is mounted on an outer ring 73 of stationary side.

The cover member 72 has a sealing lip 74 bonded thereto via vulcanization and protects the encoder 71b from influences from circumstances. A detecting sensor 75 is arranged directly adjacent to the cover member 72 and a radio signal is transmitted through the cover member 72. Accordingly it is possible to prevent the penetration of dusts or sands into a gap formed between the surfaces of the encoder 71b and a detecting sensor 75 and thus abrasion or damage of the surface of the encoder 71b (see Japanese Laid-open Patent Publication No. 160744/1998).

However, in such a bearing apparatus for a wheel of vehicle of the prior art, since the pulse generating ring 71 is arranged such that it radially extends and the signal detection of the detecting sensor 75 is carried out through the cover member 72, it is difficult to ensure sufficient area of the pulse generating ring 71 owing to the limitation of radial space of the bearing and thus the detecting sensitivity is also reduced. Especially in a vehicle such as a truck having a body of frame structure, it is difficult to keep a sufficient radial space since it requires to use a double row tapered roller bearing having a large load capacity and a wall thickness smaller than that of a double row angular ball bearing.

### SUMMARY OF THE INVENTION

It is, therefore, an object of the present invention to provide a bearing apparatus for a wheel of vehicle which can protect the encoder, improve the sensing ability of the detecting sensor as well as prevent penetration of rain water or dust and leak of the differential gear oil.

For achieving the object mentioned above, there is provided, according to the present invention of claim 1, a bearing apparatus for a wheel of vehicle comprising: an axle housing supported under a body of vehicle; a driving shaft inserted into the axle housing; and a bearing for a wheel arranged between the driving shaft and an opening of the axle housing; said bearing for a wheel comprising: an outer member formed with outer raceway surfaces on its inner circumferential surface; an inner member including a hub wheel and an inner ring, the inner ring being formed on its outer circumferential surface with inner raceway surfaces oppositely to the outer raceway surfaces; and sealing means for sealing an annular space between the inner member and the outer member characterized in that: the sealing means of inboard side of said sealing means comprises an annular supporting plate fitted onto the outer circumferential surface of one of the inner rings; a pulser ring having a encoder arranged on the outer circumferential surface of the supporting plate; and a sealing plate including a sealing member fitted onto one end of the outer member and covering the cylindrical portion of the encoder and sliding contact with the inner ring; and in that said bearing apparatus further comprises a detecting sensor suspended from the axle housing and opposed to the encoder via a predetermined radial gap; and sealing lips arranged between the sealing plate and the axle housing to seal the detecting sensor.

From the characteristic features of structure of the bearing apparatus of the present invention, it is possible to ensure sufficient flux density of the encoder even if the radial dimension of the sealing apparatus is not sufficient, prevent penetration of rain water or dust from the environment into the space between the detecting sensor and the encoder as well as prevent attraction of abraded powder mingled in the lubricating oil near or on the encoder and thus reduction of sensing ability.

According to a preferable embodiment of claim 2, since the sealing plate includes an annular core member fitted onto one end of the outer member and a lip bonded on the core member and sliding contact with the inner ring and a pair of sealing lips are bonded on the core member so that they contact the axle housing to seal either sides of the detecting sensor, it is possible to prevent penetration of rain water or dust from the environment into the space between the detecting sensor and the encoder.

According to a preferable embodiment of claim 3, since the core member is formed of non-magnetic steel plate, the radio signal can be transmitted through the core member. Accordingly, the penetration of dusts or sands into the space between the encoder and the detecting sensor is prevented and thus abrasion or damage of the surface of the encoder is also prevented.

According to a preferable embodiment of claim 4, since the core member is formed on its cylindrical portion with a sensor aperture and the detecting sensor is arranged at a position of the sensor aperture, the detecting sensor is not magnetically influenced by the core member and can be positioned via a desired air gap between the encoder and the detecting sensor. In addition it is possible to carry out the visual inspection of the state of the encoder without disassembling the sealing plate, which improves reliability of the quality of the detecting means. Furthermore, the material forming the core member is not limited to a non-magnetic steel plate and it is possible to make the core member using any steel sheet such as ferritic stainless steel or preserved cold rolled steel, which increases a range of selection of material in view of workability, cost, etc.

According to a preferable embodiment of claim 5, since the detecting sensor is inserted through the sensor aperture, it is possible to reduce the air gap between the detecting sensor and the encoder and thus improve the sensing ability without any spatial limitation.

According to a preferable embodiment of claim 6, since said sensor aperture is formed only one in a region near a vertically top of the cylindrical portion of the core member, it is possible to discharge the differential gear oil from the bottom of the bearing apparatus even if the oil would be passed through the sealing lip and thus residence of the differential gear oil mingled with abraded powder as well as its penetration into the bearing are prevented.

### EFFECTS OF THE INVENTION

Effects achieved by the present invention are concluded as follows: that is, it is possible to ensure sufficient flux density of the encoder even if the radial dimension of the sealing apparatus is not sufficient, prevent penetration of rain water or dust from the environment into the space between the detecting sensor and the encoder as well as prevent attraction of abraded powder mingled in the lubricating oil near or on the encoder and thus reduction of sensing ability.

### BEST MODE FOR CARRYING OUT THE INVENTION

According to the present invention, there is provided a bearing apparatus for a wheel of vehicle comprising: an axle housing supported under a body of vehicle; a driving shaft inserted into the axle housing; and a bearing for a wheel arranged between the driving shaft and an opening of the axle housing; said bearing for a wheel comprising: an outer member formed with outer raceway surfaces on its inner circumferential surface; an inner member including a hub wheel and an inner ring, the inner ring being formed on its outer circumferential surface with inner raceway surfaces oppositely to the outer raceway surfaces; and sealing means for sealing an annular space between the inner member and the outer member characterized in that: the sealing means of inboard side of said sealing means comprises an annular supporting plate fitted onto the outer circumferential surface of one of the inner rings; a pulser ring having a encoder arranged on the outer circumferential surface of the supporting plate; and a sealing member fitted onto one end of the outer member and covering the cylindrical portion of the encoder and sliding contact with the inner ring; and in that said bearing apparatus further comprises a detecting sensor suspended from the axle housing and opposed to the encoder via a predetermined radial gap; and sealing lips arranged between the sealing plate and the axle housing to seal the detecting sensor.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a longitudinal-section view of a first embodiment of a bearing apparatus for a wheel of vehicle of the present invention;

FIG. 2 is a partially enlarged longitudinal-section view of FIG. 1;

FIG. 3 is a partially enlarged longitudinal-section view of a second embodiment of a bearing apparatus for a wheel of vehicle of the present invention;

FIG. 4 is a partially enlarged longitudinal-section view of a bearing apparatus for a wheel of vehicle of a modification of the second embodiment;

FIG. 5 is a longitudinal-section view of a bearing apparatus for a wheel of vehicle of the prior art; and

FIG. 6 is a longitudinal-section view of an another bearing apparatus for a wheel of vehicle of the prior art.

### DESCRIPTION OF THE PREFERRED EMBODIMENTS

Preferred embodiments of the present invention will be described with reference to accompanied drawings.

### First Embodiment

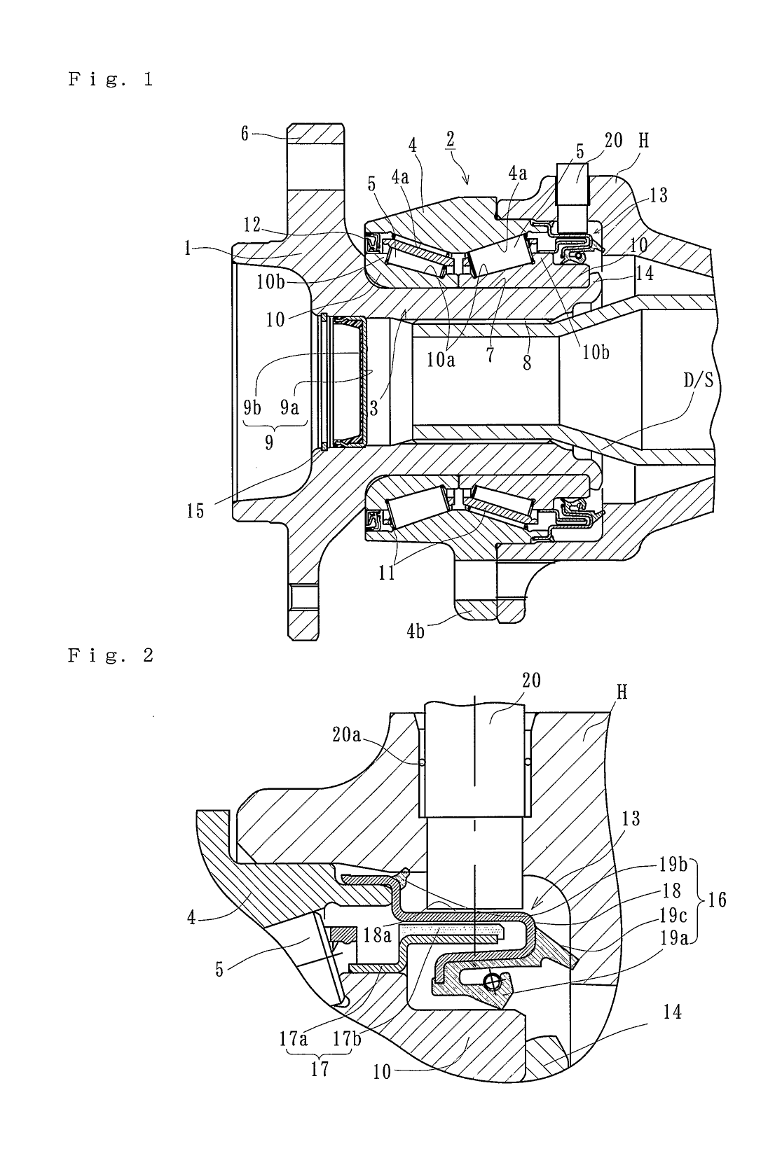

FIG. 1 is a longitudinal-section view of a first embodiment of a bearing apparatus for a wheel of the present invention, and FIG. 2 is a partially enlarged longitudinal-section view of FIG. 1. In the description of the present invention, a side of a bearing positioned outward a vehicle when it is mounted on a vehicle is referred to as “outboard” side (the left side in a drawing), and a side inward a vehicle is referred to as “inboard” side (the right side in a drawing).

In a bearing apparatus for a wheel of vehicle of the present invention, a hub wheel 1 and a double row rolling bearing 2 are formed as a unit and connected to a driving shaft “D/S”. The double row rolling bearing 2 comprises an inner member 3, an outer member 4, and a double row rolling elements (tapered rollers) 5 and 5 freely rollably contained between the inner and outer members 3 and 4. The inner member 3 includes the hub wheel 1 and a pair of inner rings 10 and 10 press-fitted onto the hub wheel 1. The hub wheel 1 is integrally formed with a wheel mounting flange 6 on which, at its outboard side, a wheel and a brake rotor (not shown) and from which an axially extending cylindrical portion 7 of smaller diameter extends. An inner circumferential surface of the hub wheel 1 is formed with a serration (or spline) 8 into which a serrated portion of the driving shaft “D/S” is inserted so that a torque can be transmitted therebetween.

The outer member 4 is formed with, on its inner circumferential surface, double row tapered outer raceway surfaces 4a and 4a and on its outer circumferential surface, a body mounting flange 4b to be secured to an axle housing “H”. Each of the pair of the inner rings 10 and 10 is formed with, on its outer circumferential surface, a tapered inner raceway surface 10a arranged to be opposed to the tapered outer raceway surface 4a. The double row rolling elements 5 and 5 are arranged between the outer and inner raceway surfaces 4a and 10a and freely rollably held by a cage 11. Each of the inner rings 10 and 10 is formed with, at its larger diameter end, a large flange 10b for guiding the rolling elements 5 and 5. The pair of inner rings 10 and 10 are arranged so that their inner ends are abutted each other and thus form so-called a back-abutted type double row tapered roller bearing. Sealing means 12 and 13 arranged at either ends of the outer member 4 seal an annular space between the outer member 4 and the inner rings 10. These sealing means 12 and 13 prevent both penetration of rain water or dusts from the external circumstances and lea of lubricating grease sealed within the bearing. The inboard side sealing means 13 further prevents differential gear oil from being penetrated into the inside of the bearing passing through the serration 8 of the hub wheel 1.

The pair of inner rings 10 and 10 are press fitted onto the cylindrical portion 7 of smaller diameter formed on the outer circumferential surface of the hub wheel 1 and are prevented from being axially slipped off from the cylindrical portion 7 by a caulked portion 14 formed by plastic deformation of the end of the cylindrical portion 7 radially outward. Since this embodiment adopts the self-retaining structure of the second generation, it is not required to control an amount of pre-pressure caused by fastening force of a nut used in the prior art. Accordingly, it is possible to substantially reduce the number of parts and thus to improve the readiness of assembly as well as to reduce its manufacturing cost, weight and size.

The hub wheel 1 is made of medium carbon steel such as S53C including carbon of 0.40˜0.80 wt % by weight and hardened by high frequency induction quenching so that the base of the wheel mounting flange 6 at its inboard side and the cylindrical portion 7 of smaller diameter have the surface hardness of 58˜64 HRC. The caulked portion 14 is remained as a non-quenched portion having its surface hardness less than 25 HRC. This improves the durability and workability of the caulked portion 14 and also prevents generation of cracks therein.

The outer member 4 is also made of medium carbon steel such as S53C including carbon of 0.40˜0.80 wt % by weight and the outer raceway surfaces 4a and 4a thereof are hardened by high frequency induction quenching so that their surface hardness is within 58˜64 HRC. On the other hand, the inner rings 10 is made of high carbon chrome bearing steel such as SUJ2 and hardened to its core by dipping quenching to have the surface hardness of HRC 58˜64. Although it is herein illustrated a double row tapered roller bearing using tapered roller as rolling elements 5 and 5, the double row angular ball bearing using balls may be also used.

A cap 9 is press-fitted into an opening of the hub wheel 1 at its outboard side. This cap 9 is made of austenitic-stainless steel sheet (JIS SUS 304 etc.) or preserved cold rolled steel sheet (JIS SPCC etc.) and formed as an annular shape by press working. The cap 9 comprises a core member 9a of steel formed as having a substantially “C”-shaped cross-section, and a elastic member 9b of rubber bonded via vulcanization to at least the fitting portion of the core member 9a. The elastic member 9b is elastically deformed during the cap 9 is press-fitted into the opening of the hub wheel 1 to seal the opening for surely preventing penetration of rain water or dusts from the ambient circumstances into the driving shaft “D/S” and thus into the differential gear oil. A numeral 15 denotes a snap ring to prevent the cap 9 from being slipped off from the hub wheel 1.

As shown in an enlarged cross-section view of FIG. 2, the sealing means 13 of inboard side comprises an annular sealing plate 16 fitted onto the outer circumferential surface of one end of the outer member 4, and an annular pulser ring 17 fitted onto the outer circumferential surface of the inner ring 10. The sealing plate 16 comprises a core member 18 made of non-magnetic steel plate such as austenitic-stainless steel sheet (e.g. JIS SUS 304 etc.), and a sealing member 19 including a radial lip 19a slide-contacting to the outer circumferential surface of the inner ring 10, and sealing lips 19b and 19c contacting to the inner circumferential surface and the side wall of the axle housing “H”. These radial lip 19a and sealing lips 19b and 19c are bonded to the core member 18 via vulcanization. The radial lip 19a prevents leak of the lubricating grease contained within the bearing and penetration of the differential gear oil into the bearing and the sealing lips 19b and 19c prevent leak of the differential gear oil to the ambient circumstances and penetration of rain water or dusts into the bearing apparatus.

The pulser ring 17 comprises a supporting plate 17a, and a encoder 17b bonded on the outer circumferential surface of the supporting plate 17a. The supporting plate 17a is made of ferromagnetic steel sheet, e.g. ferrite-stainless steel sheet (JIS SUS 430 etc.) or preserved cold rolled steel sheet (JIS SPCC etc.) and formed as an annular member by press working.

The encoder 17b is made of elastomer material such as rubber with which magnetic material powder such as ferrite powder is mingled and in which N and S poles are alternately magnetized at a predetermined pitch along the circumferential direction thereof. Although here is shown the encoder 17b made of elastomer, it is possible to make the encoder 17b by any other material e.g. sintered material in which ferromagnetic material powder is mingled with metal binder.

The detecting sensor 20 is suspended on the axle housing H via an elastic member 20a such as O-ring 20. The detecting sensor 20 is formed for example by magnetic detecting element such as a Hall effect element, a magnetroresistant effect element (MR element) etc. for varying its characteristics in accordance with the direction of flux, and IC into which wave shaping circuit for shaping the output wave of the MR element is incorporated. The detecting sensor 20 is arranged so that it is opposed to the encoder 17b of the pulser ring 17 via a predetermined radial gap (air gap) therebetween. Such an arrangement enables to increase the flux density of the encoder 17b and to improve the rotation sensing ability even if the radial space of the bearing, particularly the radial height of the sealing means 13 is not sufficiently ensured. In addition, since the detecting sensor 20 is arranged directly adjacent to the core member 18, the radio signal can be transmitted through the core member 18 of non-magnetic material. The core member 18 also makes it possible to prevent the penetration of dusts or sands into a gap formed between the surfaces of the encoder 17b and a detecting sensor 20 and thus to prevent abrasion or damage from being caused on the surface of the encoder 17b by sands or dusts. The detecting sensor 20 may be arranged so that it contacts the outer circumferential surface of the cylindrical portion 18a of the core member 18.

According to this embodiment since sealing lips 19b and 19c are arranged at either sides of the detecting sensor 20, it is possible to prevent penetration of rain water or dusts from the ambient circumstances into the gap between the detecting sensor 20 and the encoder 17b and also to prevent penetration of the differential gear oil mingled with abraded iron debris into the bearing. Thus it is possible to improve both protection of the encoder 17b and the detecting ability.

### Second Embodiment

FIG. 3 shows a second embodiment of the bearing apparatus for a wheel of vehicle of the present invention. Since difference of this embodiment from the first embodiment only resides in the structure of the sealing, same numerals are used as those used in the first embodiment for designating the same structural elements.

A sealing means 13 of inboard side of this embodiment comprises an annular sealing plate 21 fitted on the outer circumferential surface of one end of the outer member 4, and a pulser ring 17 mounted on the outer circumferential surface of one end of the inner member 10. The sealing plate 21 comprises a core member 22, the radial lip 19a slide-contacting to the outer circumferential surface of the inner ring 10, and sealing lips 19b and 19c contacting to the axle housing “H”. These radial lip 19a and sealing lips 19b and 19c are bonded to the core member 22 via vulcanization.

The sealing plate 21 is substantially same as the sealing plate 16 except that a sensor aperture 23 through which the detecting sensor 20 is inserted is formed in a cylindrical portion 22a of the core member 22. The sensor aperture 23 is formed only one in a region near a vertically top of the cylindrical portion 22a of the core member 22. The arrangement in which the detecting sensor 20 is inserted through the sensor aperture 23 enables to substantially reduce the air gap between the encoder 17b and the detecting sensor 20 and thus to improve the sensing ability of the sensor 20 without any spatial limitation. In addition, the material forming the core member 22 is not limited to a non-magnetic steel plate such as an austenitic-stainless steel sheet (JIS SUS 304 etc.) and it is possible to make the core member 22 using any steel sheet such as a ferritic stainless steel sheet (JIS SUS 430 etc.) or preserved cold rolled steel sheet (JIS SPCC etc.), which increases a range of selection of material in view of workability, cost, etc.

According to this embodiment, since the detecting sensor 20 is inserted through the sensor aperture 23 of the core member 22 and arranged directly opposed to the encoder 17b, and since sealing lips 19b and 19c are arranged at either sides of the detecting sensor 20, it is possible to prevent penetration of rain water or dusts from the ambient circumstances into the gap between the detecting sensor 20 and the encoder 17b and also to prevent penetration of the differential gear oil mingled with abraded iron debris into the bearing. The detecting sensor 20 is not magnetically influenced by the core member 22 and can be positioned via a desired air gap between the encoder 17b and the detecting sensor 20. In addition it is possible to carry out the visual inspection of the state of the encoder 17b without disassembling the sealing plate 21, which improves reliability of the quality of the detecting means. Furthermore, since sensor aperture 23 is formed only one in a region near a vertically top of the cylindrical portion of the core member 22, it is possible to discharge the differential gear oil from the bottom of the bearing apparatus even if the oil would be passed through the sealing lip 19c and thus residence of the differential gear oil mingled with abraded powder as well as its penetration into the bearing are prevented.

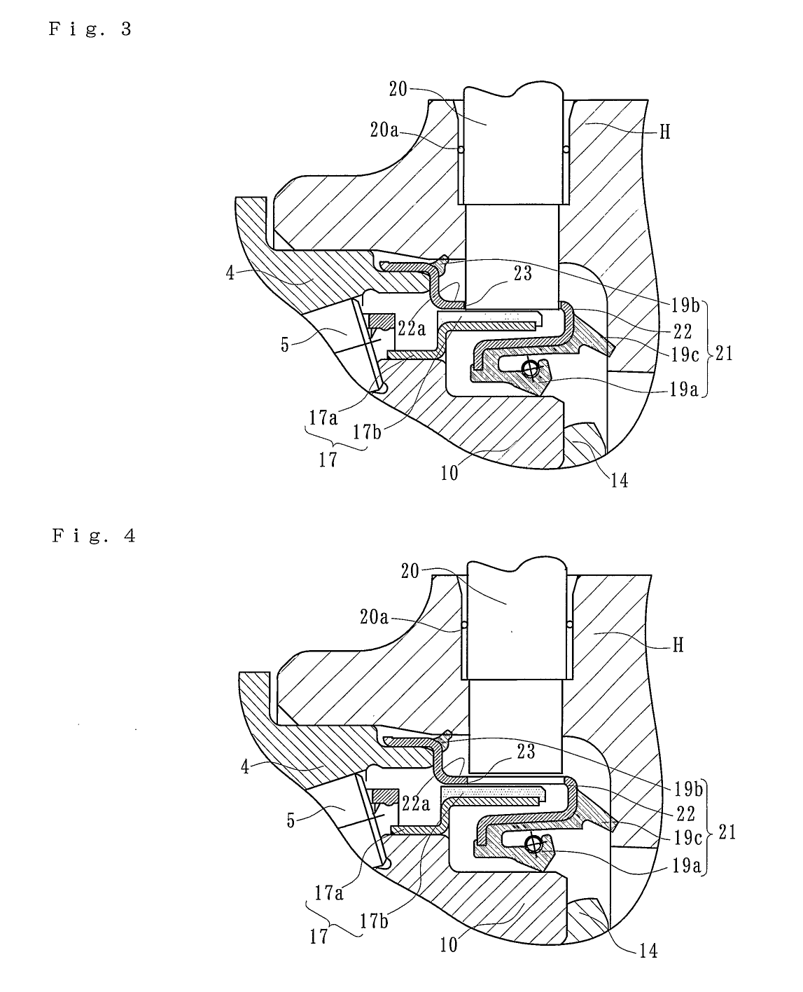

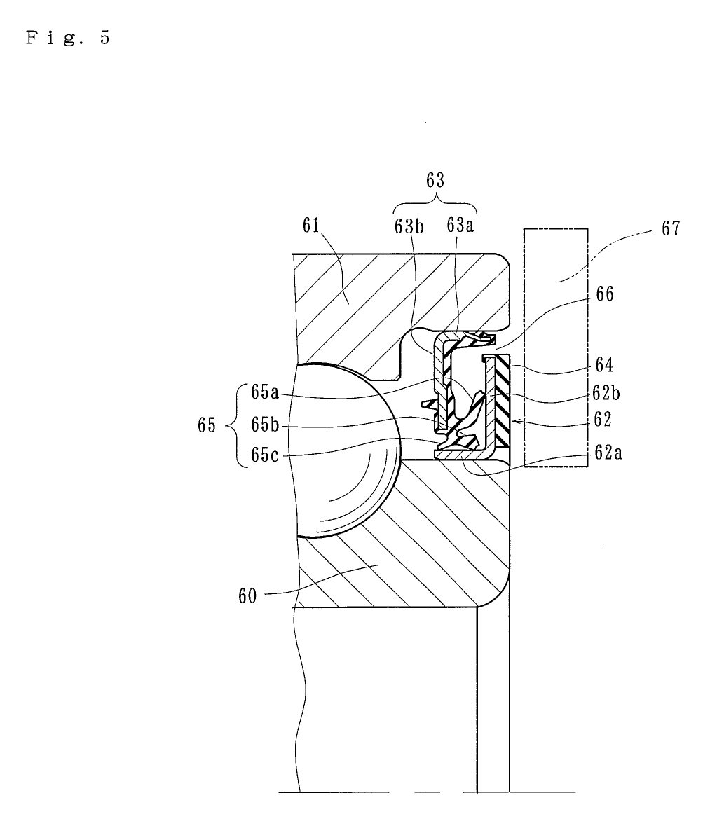

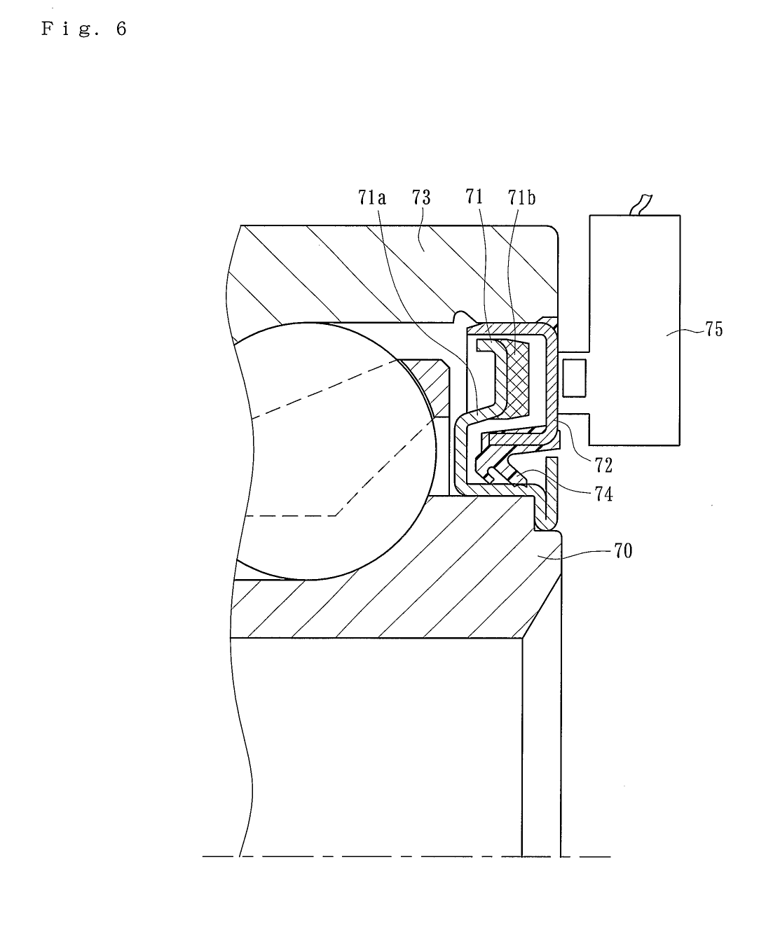

FIG. 4 shows a modification of the second embodiment (FIG. 3). In this modification, the detecting sensor 20 is arranged so that it is not inserted through the sensor aperture 23 of the core member 22 and positioned opposed to the encoder 17b via a predetermined air gap. Accordingly, this modification exhibits same effect as that of the second embodiment and thus the positioning of the detecting sensor 20 can be simplified as well as workability of assembly of the bearing apparatus is also improved. In addition, the bearing portion can be disassembled from the axle housing “H” without removing the detecting sensor 20 from the axle housing “H” in service of the bearing apparatus.

The present invention has been described with reference to the preferred embodiment. Obviously, modifications and alternations will occur to those of ordinary skill in the art upon reading and understanding the preceding detailed description. It is intended that the present invention be construed as including all such alternations and modifications insofar as they come within the scope of the appended claims or the equivalents thereof.

### APPLICABILITY IN INDUSTRY

The bearing apparatus for a wheel of vehicle can be applied to any bearing apparatus for a wheel of vehicle of driving wheel side in which the bearing is arranged at openings of the driving shaft and the axle housing despite of the structure of bearing portion.

What is claimed is:

1-6. (canceled)

7. A vehicle wheel bearing apparatus comprising:
an axle housing supported under a body of a vehicle;
a drive shaft inserted into the axle housing; and
a wheel bearing arranged between the drive shaft and an opening of the axle housing; said wheel bearing for a wheel comprising:
an outer member formed with outer raceway surfaces on its inner circumferential surface;
an inner member including a wheel hub and a pair of inner rings, the inner rings being formed on their outer circumferential surface with inner raceway surfaces opposite to the outer raceway surfaces;
a sealing mechanism for sealing an annular space between the inner member and the outer member;
the sealing mechanism of an inboard side of said sealing mechanism comprises an annular supporting plate fit onto the outer circumferential surface of one of the inner rings, a pulser ring having a encoder arranged on the outer circumferential surface of the supporting plate, and a sealing plate including a sealing member fit onto one end of the outer member and covering the cylindrical portion of the encoder and in sliding contact with the inner ring; and
said bearing apparatus further comprises a detecting sensor suspended from the axle housing and opposing the encoder via a predetermined gap, and sealing lips arranged between the sealing plate and the axle housing to seal the detecting sensor.

8. The vehicle wheel bearing apparatus of claim 1 wherein
the sealing plate includes an annular core member fit onto one end of the outer member and a lip bonded on the core member and in sliding contact with the inner ring; a pair of sealing lips are bonded on the core member so that they contact the axle housing to seal either side of the detecting sensor.

9. The vehicle wheel bearing apparatus of claim 2, wherein said core member is formed of a non-magnetic steel plate.

10. The vehicle wheel bearing apparatus of claim 2, wherein said core member is formed on its cylindrical portion with a sensor aperture and the detecting sensor is arranged at a position of the sensor aperture.

11. The vehicle wheel bearing apparatus of claim 4, wherein said detecting sensor is inserted through the sensor aperture.

12. The vehicle bearing apparatus of claim 4, wherein said sensor aperture is formed by only one at or near the top of said cylindrical portion forming the core member.

13. The vehicle wheel bearing apparatus of claim 3, wherein said core member is formed on its cylindrical portion with a sensor aperture and the detecting sensor is arranged at a position of the sensor aperture.

14. The vehicle bearing apparatus of claim 5, wherein said sensor aperture is formed by only one at or near the top of said cylindrical portion forming the core member.
